(19) United States
(12) Patent Application Publication
(10) Pub. No.: US 2010/0206995 A1
(43) Pub. Date: Aug. 19, 2010

(54) METHOD FOR THREE-DIMENSIONAL GROUP CONTROL OF MOVING OBJECTS

(76) Inventor: Yoshinobu Inada, Tokyo (JP)

Correspondence Address: Cheng Law Group, PLLC, 1100 17th Street, N.W., Suite 503, Washington, DC, 20036, US

(21) Appl. No.: 12/581,942

(22) Filed: Oct. 20, 2009

(30) Foreign Application Priority Data
Feb. 19, 2009 (JP) 2009-36116

(51) Int. Cl. G05D 1/10

(52) U.S. Cl. 244/76 R

(57) ABSTRACT

Problems to be solved by the present invention relate to group control of moving objects in three dimensions, and the invention proposes a group control method, unlike conventional cumbersome methods, the method being stably provided with a function of causing a group to move in the same direction while preserving the aggregate form of the group, and with a function of causing the group to turn around a fixed point in the vicinity of an operational target. The method for three-dimensional group control of moving objects according to the present invention includes: setting, around individual moving objects, an interaction zone formed in a spherical or ellipsoidal three-layer structure of, sequentially from outside to inside thereof, an approach zone, a parallel-orientation zone and a repulsion zone; and employing, as an algorithm, a behavior model which comprises an approach rule, a parallel-orientation rule and a repulsion rule depending on the zone at which a neighbor moving object is present.

### BACKGROUND OF THE INVENTION

1. Field of the Invention

The present invention relates to a technology for controlling the motion and the shape of groups comprising a plurality of robots or flying objects as used in the fields of control engineering, aeronautical engineering and robot engineering.

2. Description of the Related Art

Aircraft capable of instantaneous gathering of information from the air are highly effective for early appraisal of disasters such as strong local earthquakes in urban areas. However, when the conventional large size aircraft is used, airfield sites are confined to the outskirts of cities, and are thus removed from urban centers, while the number of aircraft that can be used simultaneously is likewise limited because of the operational cost and/or noise problem. This imposes constraints, as a result, on the use of aircraft when required and where required. Therefore, some approaches advocate airborne monitoring of the unfolding disaster by deploying multiple unmanned flying objects all over a city. The flying objects in this case should preferably be small flying objects (Micro Air Vehicles: MAVs), with a view to minimizing the operational cost and the noise problem, and also minimizing the danger of a secondary disaster brought about by crashing of the flying objects. However, the equipment that can be placed on board of state-of-the art MAVs is limited, while the reliability of the vehicles themselves is also problematic due to the susceptibility to aerial disturbances. To address these problems, therefore, it is necessary to consider some “MAV group control” that can deal with multiple MAVs as a single group. The advantages of group control include the ability of gathering quickly information in a three-dimensional space through simultaneous multi-point measuring by way of multiple aircraft. Although the functionality of a single aircraft is limited, the group as a whole can realize a wide variety of functions by combining aircraft in which various sensors are carried by different aircraft. In a conceivable operation, for instance, the evolution of a fire is grasped in real time and in three dimensions by relying on a combination of flying aircraft carrying each a small camera, temperature sensor or gas sensor. A further advantage lies in the fact that the functionality of the whole can be preserved even if a few aircraft are lost on account of, for instance, malfunction or disturbances. The control systems that can be installed in MAVs, however, are lighter and have fewer functions than those of larger aircraft. It is therefore necessary to implement group control using algorithms that are as simple as possible.

Attempts at group control have mainly been directed in the art at surface-moving robots, where the purpose of group control is to distribute a task over a plurality of robots. Thus, technical developments have focused mainly on task division and coordinated control. These control schemes operated basically at one location or over a limited area, and did not involve motion of the group of robots as a whole over long distances (Japanese Patent Application Laid-open No. 2008-158841 “Autonomous movement device group control system”, published on 10 Jul. 2008; Japanese Patent Application Laid-open No. 2006-346770, “Control system for robot group, and robot”, published on 28 Dec. 2006. However, there are instances where the robot group itself must move, such as when the current position of the robots is removed from the operation target, or when the operation target is spread over a wide area, or when the target does not remain stationary but moves as well. Examples of conventional technologies relating to the motion of robot groups include, for instance, motion control of a plurality of automobiles or train vehicles. These motion control schemes, however, are control methods dealing with motion along definite pathways, such as roads or tracks, with the vehicles coupled mechanically to each other. The degrees of freedom to be controlled were thus limited. (Japanese Patent Application Laid-open No. 2008-59094 “Vehicle group control system”, published on 13 Mar. 2008; Japanese Patent Application Laid-open No. 2003-95109, “train group control system”, published on 3 Apr. 2003).

Group control of flying objects that fly freely in three-dimensional space include, for instance, control of formation flight of aircraft or artificial satellites. These control schemes involved realizing formation flight by defining a given aircraft as a main aircraft (master) and treating the remaining aircraft as subordinate aircraft (slaves), such that the relative position of an own subordinate aircraft is determined by referring to the position of the main aircraft (Japanese Patent Application Laid-open No. 2004-210032, “Formation flight satellite”, published on 29 Jul. 2004; Japanese Patent Application Laid-open No. H11-139396, “Formation flight control device”, published on 25 May 1999). These control schemes were problematic in that the arrangement of the aircraft in the formation is affected by the state of the main aircraft, such that fluctuations in the position of the main aircraft, on account of disturbances or the like, affected all the other aircraft. When the main aircraft became unusable through malfunction, moreover, it was necessary to designate a new main aircraft and to redefine the relative position of the subordinate aircraft, all of which added to the control load devoted to changes in settings and/or position changes.

Besides moving to a same target destination while avoiding collisions, a further goal in group control of flying objects arises after arrival at the target destination, in that data has to be gathered while moving around the target under examination. It is also necessary to safely circumvent any obstacles that may be encountered while preserving the state of the group. No conventional technologies afforded that kind of group control of moving objects, and hence such technologies had to be created from scratch. As a result of research on the group movement of living beings, meanwhile, prior art documents (Aoki, L., 1982. “A simulation study on the schooling mechanism in fish”. Bull. Jpn. Soc. Sci. Fish. 48:1081-1088) had reported findings to the effect that stable group movement can be realized based on simple algorithms. FIG. 9 illustrates a behavior model of fish schools such as the one proposed in the above prior art document. The model postulates interaction zones laid out as a structure of three layers A, B, C surrounding an individual. The individual at the center of the zone decides the direction of its motion depending on the zone at which a neighbor individual is present. FIG. 10 illustrates such decision rules. 1) When a neighbor individual is present in an outermost zone A, the individual at the center changes its orientation towards the neighbor individual so as to approach the latter (approach rule). 2) When a neighbor individual is present in a zone B, the individual at the center adopts an orientation identical to the motion direction of the neighbor individual, and advances in that heading (parallel-orientation rule). 3) When a neighbor individual is present in an innermost zone C, the individual at the center turns away from the neighbor individual so as to move away from the latter (repulsion rule).

### SUMMARY OF THE INVENTION

The inventors have researched the possibility of developing algorithms for group control of moving objects by applying the above-described behavior models of fish schools to flying objects, robots and the like.

The problem to be solved by the invention is to provide a group control method relating to group control of moving objects such as flying objects, submersibles, land robots and the like, as yet unachieved in conventional art. Specifically, the invention aims at providing a group control method that embodies the following functions.

1) A function of causing a group comprising a plurality of moving objects to move in the same direction while preserving the aggregate form of the group.

2) A function of changing, as needed, the motion direction of a group comprising a plurality of moving objects.

3) A function of causing a group comprising a plurality of moving objects to turn around a fixed point in the vicinity of an operational target.

4) A function of causing a group comprising a plurality of moving objects to avoid obstacles encountered by the group, by changing the shape of the group.

5) A function of, upon malfunction-derived loss or the like of some moving objects of a plurality thereof that makes up a group, preventing the remaining moving objects from being affected, even if there changes the number of moving objects that make up the group.

The group control algorithm for moving objects of the present invention involves setting a two-dimensional, three-layer structure interaction zone (FIG. 9) around individual moving objects, as proposed in the above prior art document, and expanding the fish school behavior model (FIG. 10), which comprises an approach rule, a parallel-orientation rule and a repulsion rule in accordance with the interaction zone, to group control of moving objects. The group control method comprises the steps of setting a zone, similar to the interaction zone of the behavior model of fish schools, around aircraft, and rotating the zone about the front-rear axis to create an interaction zone having a three-dimensional spherical structure, similarly to the one illustrated in FIG. 1. The internal structure of the zone, as is the case in the two-dimensional model of FIG. 9, comprises an arrangement of three concentric spherical zones sequentially including, from the outside inwards, an approach zone A, a parallel-orientation zone B and a repulsion zone C. The fish school model of FIG. 9 postulates an invisible zone, behind the body, that cannot be reached by the visual field. In the three-dimensional model of the present invention an invisible zone is set as well, to account for the possible absence of sensors at the rear of the robots or flying objects. This zone can be omitted if rear sensors are provided. The invention proposes thus a group control algorithm the overall features whereof are set forth below.

An aircraft positioned at the center of the interaction zone (hereafter “target aircraft”) determines an own motion direction on the basis of which zone of the interaction zone is occupied by a neighbor aircraft. This rule is identical to that of the two-dimensional model. As illustrated in FIG. 2, the target aircraft approaches an aircraft present in zone A, advances in the same direction as that of an aircraft present in zone B, and moves away from an aircraft present in zone C. The motion direction vectors (unit vectors) of the target aircraft are set to (αₐₚₚ, αₚₐᵣₐ, αᵣₑₚᵤₗ).

The distance between a target aircraft and a neighbor aircraft, and the motion direction of a neighbor aircraft can be grasped by installing, in each aircraft, a position information acquisition device such as GPS or the like, an aircraft direction acquisition device such as a magnetic heading sensor, and communication equipment for exchanging information between aircraft. The motion direction and distance to a neighbor aircraft can be grasped then through exchange between aircraft, by way of the communication equipment, of own-position and motion direction information acquired using such position information acquisition devices and aircraft direction acquisition devices.

The target aircraft is set to have directionality in the interaction direction, as illustrated in FIG. 3. Interaction aircraft are selected, from among the neighbor aircraft that are present in the interaction zone, in accordance with a rule that gives greater preference to neighbor aircraft that are closer to a direction vector δ (dₓ, d_{y}, d_{z}) denoting directionality at that time. An operator may also set the orientation of directionality to any orientation.

When multiple neighbor aircraft are present in the interaction zone there is set a maximum value (N_{b,max}) of aircraft that can interact simultaneously. If the number of neighbor aircraft is greater than this value, a number N_{b,max} of aircraft are selected in order or proximity to a preferential direction, in accordance with the above-described interaction directionality. If the number of neighbor aircraft is smaller than N_{b,max}, then all the aircraft are interacting.

To determine the motion direction of target aircraft when plural aircraft are present in the interaction zone, there is determined a motion direction for interacting target aircraft selected in accordance with the method described in the preceding paragraph, on the basis of the approach rule, the parallel-orientation rule and the repulsion rule. The orientation of the average vector of the motion direction vectors determined for each aircraft is taken eventually as the motion direction of the target aircraft.

Turning flight around a fixed point, such as the one illustrated in FIG. 4, is realized using the above-described interaction directionality. FIG. 4A on the left is an image diagram depicting envisioned information gathering and fire fighting in a fire area, in which an aircraft group flies around the area after arrival to the fire area. Such turning flight by the aircraft can be realized by causing the directionality of each aircraft to be tilted towards the turning center. The turning radius can be modified by changing the angle of inclination of the directionality. FIG. 4B on the right illustrates the simulation results for a group of 200 aircraft the movement of which is controlled in accordance with the behavior rules of the present invention.

When it is necessary to change the group shape in order to avoid an obstacle, or in accordance with the operational purpose, the present invention allows modifying the group shape by utilizing a correlation that arises between the shape of the interaction zone around an aircraft and the shape of the whole group. This correlation is a relationship wherein the shape formed by the group as a whole is substantially analogous to the shape of the interaction zone that surrounds the aircraft. The shape of the group can be modified in that when the whole group is arranged elongately in the direction along which the group advances, the shape of the interaction zone is not spherical, as illustrated in FIG. 1, but ellipsoidal, as illustrated in FIG. 5A, with the long axis running along the front-rear (X-axis) direction. When the group is arranged elongately in the transversal direction relative to the direction of advance, the group takes on an ellipsoidal shape the long axis whereof runs in the horizontal (Y-axis) direction, as illustrated in FIG. 5B. When the group is arranged elongately in the vertical direction, the group takes on an ellipsoidal shape the long axis whereof runs in the vertical (Z-axis) direction, as illustrated in FIG. 5C.

An explanation follows next on a procedure for moving an aircraft group from point A to point B. When the flight path of the aircraft flying in formation is controlled by external command or is controlled autonomously by a guidance system in the aircraft, in accordance with conventional technologies for path control of single aircraft, each aircraft changes its motion direction upon reception of an external command, or changes its motion direction in response to a command issued by the guidance system of the aircraft. In the present invention, by contrast, path control of the whole group is realized by carrying out path control not for every aircraft, but only for some aircraft, such that the remaining aircraft follow the controlled aircraft through interaction therewith. The proportion of aircraft for which path control is carried out relative to all the aircraft varies depending on the amount of variation in the motion direction. FIG. 6 illustrates this concept. FIG. 6A is an image diagram illustrating path control of the whole group through path control of some aircraft. FIG. 6B is a graph illustrating simulation results. The horizontal axis in the graph represents the proportion of aircraft under path control, and the vertical axis represents a tracking success ratio. The tracking success ratio is the ratio of aircraft, not being path-controlled, that have performed tracking successfully after ten simulations in which the position of each aircraft is changed from that upon simulation start, other conditions remaining unchanged. The figure shows that when one path variation (Δφ) is large, the group breaks up unless the proportion of aircraft being path-controlled is increased. When path variation is small, however, path control is possible, without breakup of the whole group, even if the proportion of path-controlled aircraft is reduced. For instance, when Δφ=40°, a tracking success ratio of 100% is impossible unless 90% or more of the aircraft are path-controlled. When Δφ=20°, by contrast, the tracking success ratio can reach 100% even when the proportion of controlled target aircraft is 50%, i.e. even when only half the aircraft are path-controlled. This indicates that path control of the whole group can be made possible even when external commands fail to reach all aircraft, on account of impaired communication conditions, or even when some aircraft cannot be path-controlled through malfunction of the guidance system in the aircraft. This feature makes it unnecessary to equip all aircraft with costly guidance systems, and affords thus an effective way of cutting group control costs.

The present invention can be summarized as follows.

The method for three-dimensional group control of moving objects according to the present invention comprises: setting, around individual moving objects, an interaction zone formed in a spherical or ellipsoidal three-layer structure of, sequentially from outside to inside thereof, an approach zone, a parallel-orientation zone and a repulsion zone; and employing, as an algorithm, a behavior model which comprises an approach rule, a parallel-orientation rule and a repulsion rule depending on the zone at which a neighbor moving object is present.

The approach rule yields a direction towards a neighbor moving object, the parallel-orientation rule yields a motion direction identical to that of the neighbor moving object, and the repulsion rule yields a direction along which a vector c1 or c2 forms the smallest angle with a motion vector b of an object aircraft, the vectors c1 and c2 lying within a plane defined by the motion vector b and a position vector a of a neighbor moving object, such that c1 and c2 have the same origin as a and are perpendicular to a.

The control method of the present invention for realizing a turning flight around a fixed point does so by employing an interaction directionality rule whereby an aircraft close to a specific direction is preferentially selected from among neighbor aircraft present in the interaction zone, and by tilting the specific direction towards the center pf turning. The turning radius is modified by changing the angle of the specific direction.

The control method of the present invention for realizing path control of a whole group of a plurality of aircraft does so by controlling the motion direction of one or mere aircraft among the plurality of aircraft that make up the group, and by causing the remaining aircraft to follow the one or more aircraft through interaction therewith.

In the control method of the present invention for shaping the whole group to a desired shape a correlation is used that arises between the shape of the interaction zone around an aircraft and the shape of the whole group, the shape of the interaction zone is manipulated to control thereby the shape of the whole group and achieve a desired shape.

Conventional group control technologies such as those disclosed in Japanese Patent Application Laid-open No. 2004-210032 and Japanese Patent Application Laid-open No. H11-139396, having hierarchical structures in which a group comprises a main aircraft and subordinate aircraft, were problematic in that control of the subordinate aircraft was easily influenced by changes in the state of the main aircraft. However, the group control algorithm used in the present invention, based on local interactions between aircraft, realizes formation flight on the basis of a group having identical interaction zones and rules for all the aircraft, without differentiating between a main aircraft and subordinate aircraft. This allows realizing robust group control by avoiding the influence of the main aircraft, which was a drawback in conventional technologies. The rules and interaction zones used are simple, as illustrated in FIGS. 1 and 2. Thus, rules and interaction zones can be sufficiently realized in functionally-limited small flying objects and robots.

In the method for three-dimensional group control of moving objects according to the present invention, a target aircraft senses only the interior of the interaction zone, and hence is not directly affected by phenomena outside the interaction zone. For instance, the probability that many neighbor aircraft within the interaction zone of a target aircraft be lost at the same time is very low, even if some aircraft of the group are lost during flight on account of malfunction. Therefore, the loss of a few aircraft does not preclude the remaining aircraft from flying on stably. That is, the group control method is robust against changes in the number of aircraft. This robustness is also effective in the face of an increase in the number of aircraft. For instance, adding a few more aircraft to the group does not translate into a substantial increase of the number of neighbor aircraft within the interaction zone of the target aircraft, which is thus little affected by the supplementary aircraft. Even in the case of a hypothetical large increase in the number of aircraft, the influence thereof is restricted to N_{b,max}, as described in paragraph [0009], since the target aircraft does not interact with more than a number N_{b,max} of aircraft. Therefore, the control parameters of the group do not increase significantly as the number of aircraft becomes larger, and thus group flight can be realized under substantially identical conditions.

Circular flight of a plurality of aircraft around a same point entails danger of collision if the same turning radius is set for the plural aircraft. Therefore, each aircraft must fly with a radius or an altitude slightly changed vis-à-vis other aircraft. In the present invention, however, turning around a fixed point is realized by orienting the interaction directionality of each aircraft towards the turning center, as described in paragraph

Collisions are therefore avoided thanks to the always-on interaction function, which triggers the repulsion rule when another aircraft gets too close. It is also unnecessary to designate different turning radii or flying altitude for each aircraft. Turning motion around a fixed point can be efficiently controlled by simply setting a same orientation pointing at the turning center, for the directionality of all aircraft. The turning radius can also be modified by adjusting the orientation of directionality, as described in paragraph [0010].

When the flight path of the aircraft flying in formation is controlled by external command or is controlled autonomously by a guidance system in the aircraft, in accordance with conventional technologies for path control of single aircraft, each aircraft changes its motion direction upon reception of an external command, or changes its motion direction in response to a command issued by the guidance system of the aircraft. In the present invention, by contrast, path control of the whole group is realized by carrying out path control not for every aircraft, but only for some aircraft, such that the remaining aircraft follow the controlled aircraft through interaction therewith. The proportion of aircraft for which path control is carried out relative to all the aircraft depends on the amount of variation in the motion direction, as illustrated in FIG. 6. This indicates that path control of the whole group can be made possible even when external commands fail to reach all aircraft, on account of impaired communication conditions, or even when some aircraft cannot be path-controlled through malfunction of the guidance system in the aircraft. This feature makes it unnecessary to equip all aircraft with costly guidance systems, and affords thus an effective way of cutting group control costs.

As a method of controlling the shape of a group for obstacle avoidance or for an operational purpose, conventional technologies for controlling the position of flying objects involve controlling each aircraft by calculating the position coordinates of each aircraft in concert with the shape of the group. In such methods, however, the position coordinates of all aircraft must be recalculated every time that the group shape changes. The control load is thus non-negligible at all times, in order to preserve designated positions when the latter fluctuate on account of perturbations or the like. In the present invention, by contrast, the same shape may be set for the interaction zones of all aircraft, while there is no need for designating a specific position of each aircraft. As a result, group shape control can be realized with a very small control load. That is, obstacles can be efficiently avoided by modifying the shape of the interaction zone, as illustrated in FIG. 5, where group shape can be easily controlled by, for instance, arranging the group elongately in the horizontal direction for ground survey, or by arranging the group elongately in the vertical direction for studying temperature or humidity distributions.

### BRIEF DESCRIPTION OF THE DRAWINGS

FIG. 1 is a diagram illustrating a three-dimensional interaction zone model used in the present invention;

FIG. 2 is a diagram illustrating motion direction determination rules of the three-dimensional group control model used in the present invention;

FIG. 3 is a diagram for explaining interaction directionality used in the present invention;

FIG. 4 is a diagram for explaining an aspect of turning flight around a fixed point in the present invention;

FIG. 5 is a diagram for explaining an aspect of group shape control in the present invention;

FIG. 6 is diagram for explaining an aspect of whole-group path control used in the present invention;

FIG. 7 is a diagram for explaining motion direction determination by a repulsion rule used in the present invention;

FIG. 8 is a flowchart for explaining a working example of a system using a group control algorithm of the present invention;

FIG. 9 is a diagram illustrating a two-dimensional interaction zone of a fish school model disclosed in the prior art; and

FIG. 10 is a diagram for explaining a motion direction determination rule in a fish school model disclosed in the prior art.

### DESCRIPTION OF THE PREFERRED EMBODIMENTS

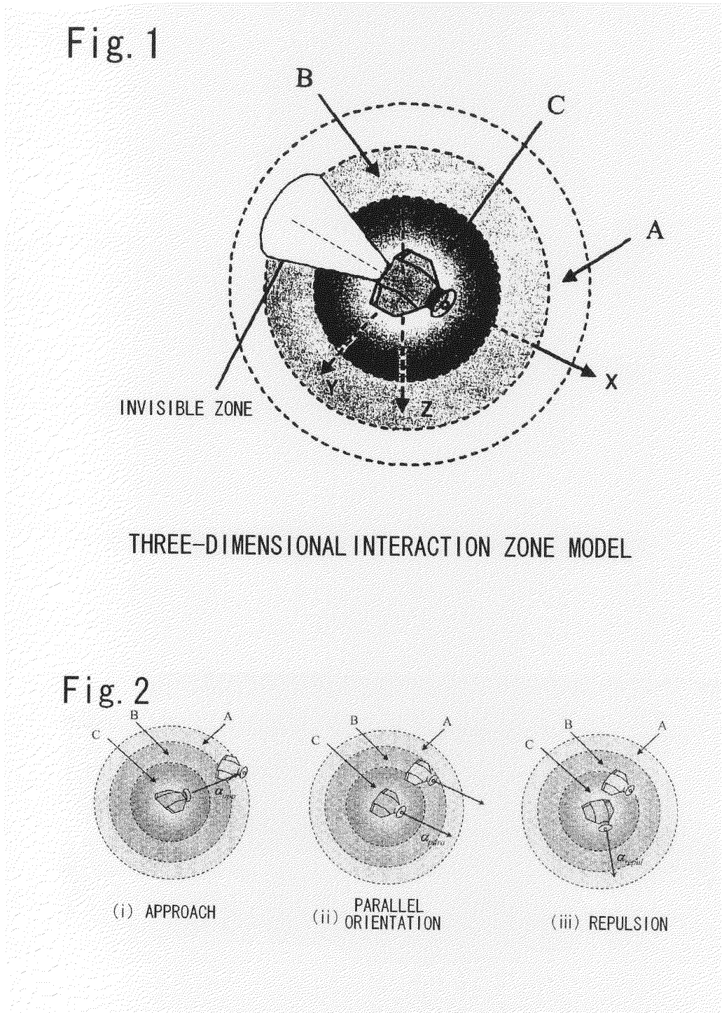

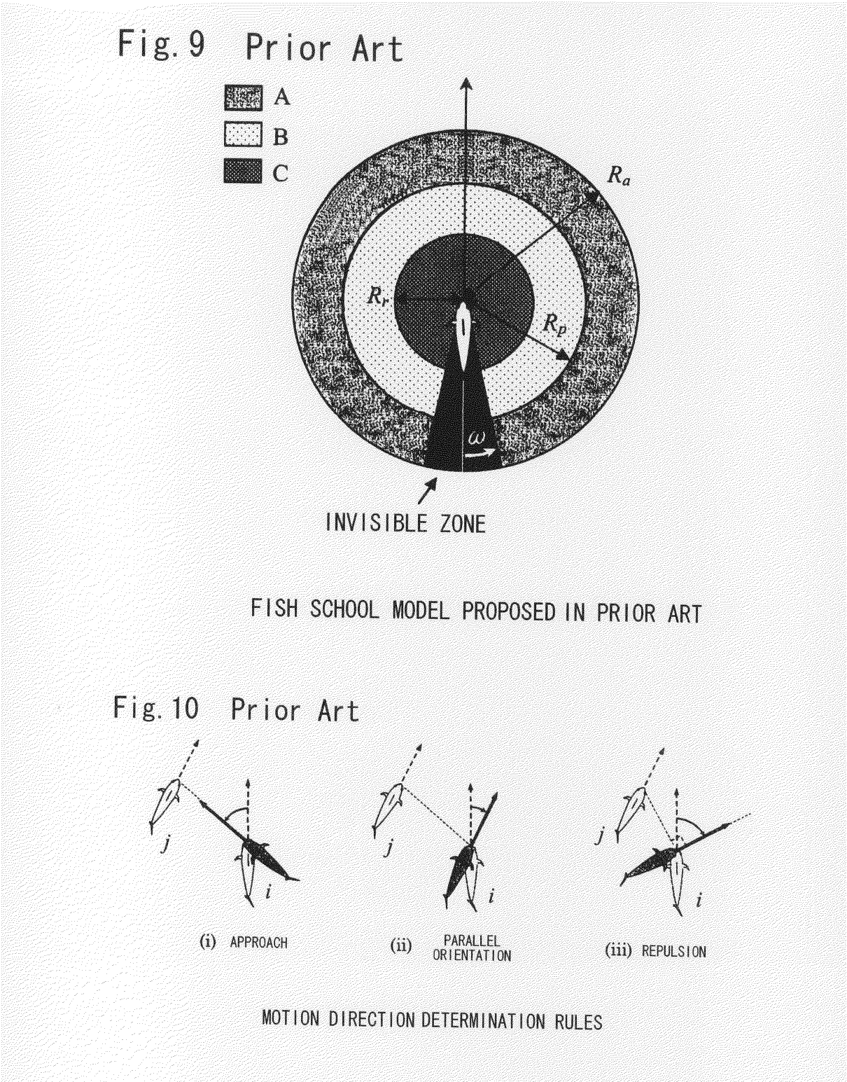

An explanation follows next on an embodiment of an interaction zone in the group control method of the present invention. The basic embodiment of the interaction zones as used herein comprise three concentric spherical zones, of different radii, centered around a target aircraft. The zones A, B and C are sequentially disposed in this order, from the outermost zone. Aircraft interact with neighbor aircraft in accordance with specific rules when a neighbor aircraft is present at a respective zone. In a standard form, the zones adopt a spherical three-layer structure such as the one illustrated in FIG. 1. The zones, however, need not necessarily be spherical, and may be ellipsoidal. The correspondence between zones and rules used herein assigns an approach rule to zone A, a parallel-orientation rule to zone B and a repulsion rule to zone C. When group shape is to be controlled, the above standard form is modified in accordance with the intended purpose, given that the shape of the group corresponds to the shape of the interaction zones. For instance, when the group has an elongate shape in the front-rear, left-right or up-and-down direction, the standard form is elongated in the front-rear axis (X-axis), left-right axis (Y-axis) or up-and-down axis (Z-axis), respectively. In the case of robots moving in a two-dimensional plane such as the ground surface, one of the three-dimensional axes is fixed to 0, whereby the shape of the interaction zones adopts a two-dimensional concentric circle structure such as the one illustrated in FIG. 9, or a structure resulting from stretching the structure in a specific direction.

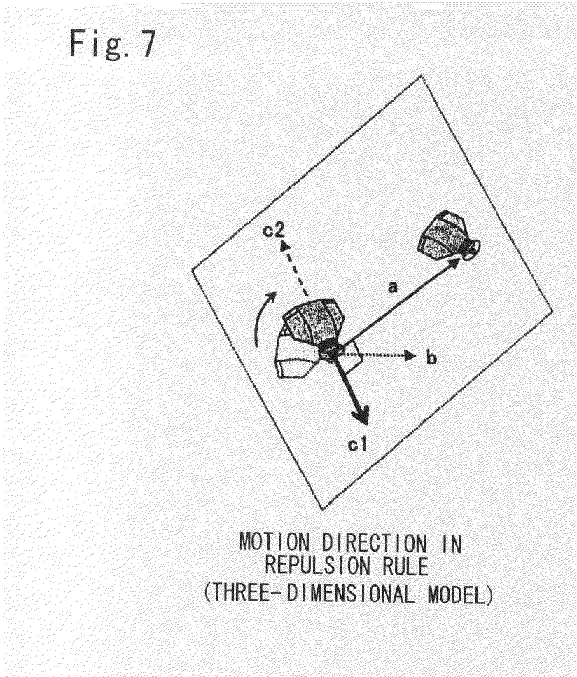

In the group control method of the present invention, interactions adopt the forms illustrated in FIG. 2, wherein an aircraft moves in accordance with three rules, namely an approach rule, a parallel-orientation rule and a repulsion rule. 1) In the approach rule, the target aircraft changes its motion direction so as to approach a neighbor aircraft. 2) In the parallel-orientation rule, the target aircraft changes its motion direction so as to point in the same direction as that of a neighbor aircraft. 3) In the repulsion rule, the target aircraft changes its motion direction so as to turn away from a neighbor aircraft. The turn-away orientation is determined as follows. With reference to FIG. 7, the motion direction vector b of the target aircraft and the position vector a of a neighbor aircraft, as seen from the target aircraft, define a plane that contains also two vectors c1 and c2, having the same origin as the vector a and perpendicular to the latter. The vector c1 or c2 that forms the smallest angle with b (c1 in FIG. 9) yields the turn-away orientation. When using the above repulsion rule in the relationship vis-à-vis a neighbor aircraft positioned behind, as seen from the target aircraft, there may be cases in which the mutual distance decreases on account of the inertia of the aircraft. In actuality, the target aircraft and the neighbor aircraft are connected with each other through the application of this rule in a state where a sizeable distance is secured, and hence the danger of a collision accident is very small. Nonetheless, it is preferable to disregard the rule when the neighbor aircraft is at a rear position as seen from the target aircraft, and let repulsion work on the basis of the repulsion rule behavior of the neighbor aircraft.

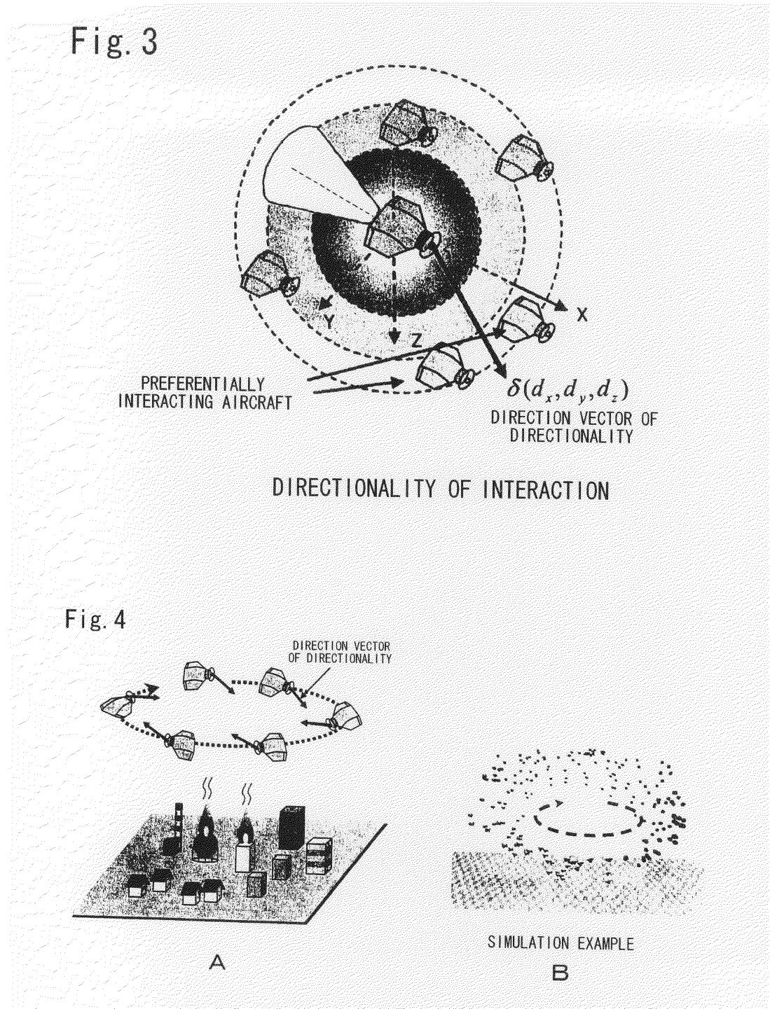

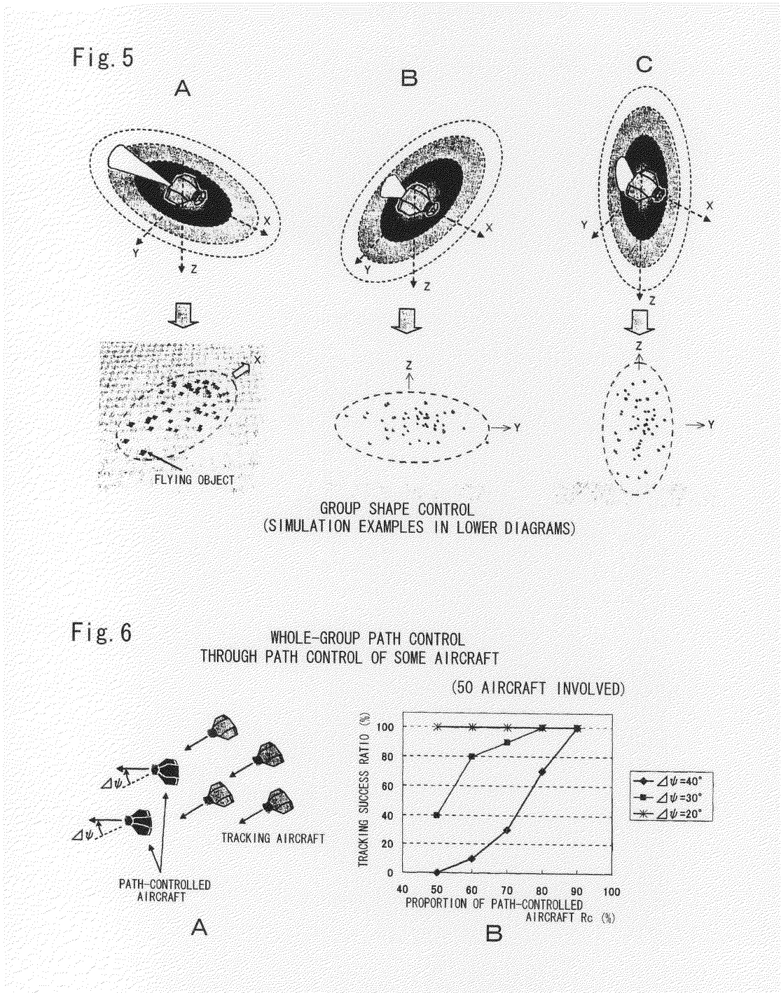

An explanation follows next on an aspect of interaction directionality in the group control method of the present invention. Directionality for interaction is specified, as the vector 6 of FIG. 3, by preferentially selecting an aircraft having a direction close to a specific direction, from among a plurality of neighbor aircraft present in the interaction zone. The basic directionality corresponds to an orientation in the X-axis direction ahead of the aircraft. In the case of turning flight around a fixed point, however, the directionality tilts towards the turning center, as illustrated in FIG. 4. The turning radius is changed by modifying the orientation of directionality.

An explanation follows next on interaction target selection and motion processing in the group control method of the present invention. When a plurality of neighbor aircraft are within an interaction zone, and the number of aircraft is greater than N_{b,max}, which is the maximum number of aircraft for which interaction applies, there are selected a number N_{b,max} of aircraft based on a preferential direction using the directionality described in paragraph [0023]. When the number of aircraft is smaller than all the aircraft are selected. A motion direction vector is determined, using the rules explained in paragraph [0022], for the selected neighbor aircraft of a target aircraft, and the direction of the average vector of the motion direction vectors of the neighbor aircraft is taken as the final motion direction. When the value of N_{b,max} is large, the influence of disturbances in the motion direction on the neighbor aircraft is ordinarily limited, thanks to the averaging effect, which stabilizes thus the final motion direction. When the value of N_{b,max} is small, the influence of disturbances is felt more readily, and thus the final motion direction is likelier to fluctuate. However, in the case of an emergency operation, such as obstacle avoidance, a large value of N_{b,max} makes the motion direction harder to change, on account of the strength of the averaging effect. By contrast, the motion direction is easier to change if the value of N_{b,max} is small. Accordingly, the value of N_{b,max} is best modified in accordance with the circumstances, so that a large N_{b,max} is adopted in environments where obstacles are few and disturbances large, and a small N_{b,max} is adopted in environments where obstacles are numerous and emergency avoidance action is frequent. In normal circumstances, a default value (for instance, N_{b,max}=4) is adopted.

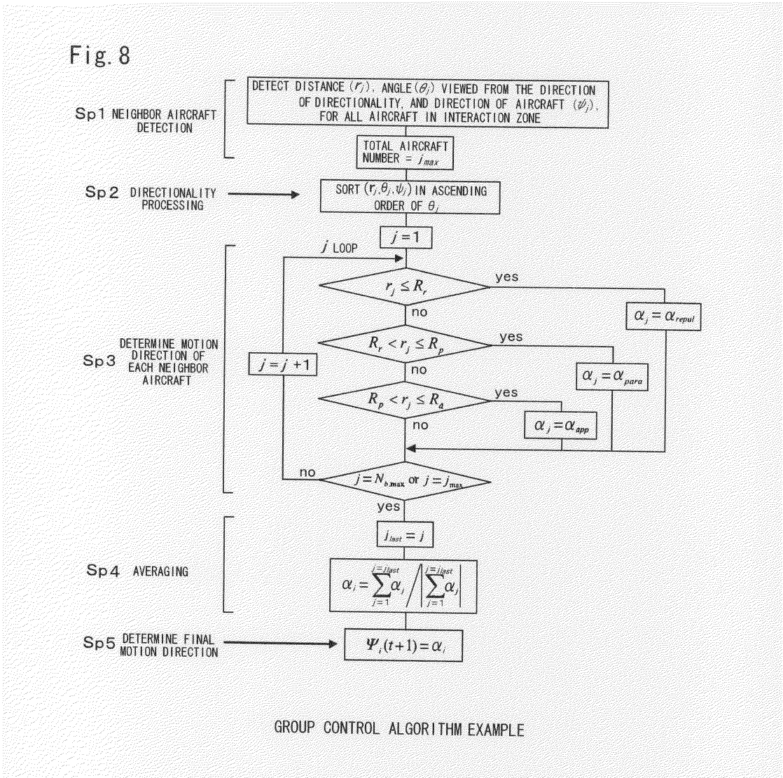

FIG. 8 is a flowchart of one process for determining the own motion direction of a target aircraft in a working example in which a target aircraft interacts with neighbor aircraft in an interaction zone. In step 1 there is detected information on distance (rⱼ), angle (θⱼ) viewed from the direction of directionality, and direction of the aircraft (ψⱼ); for all the neighbor aircraft within an interaction zone, and the total number of neighbor aircraft jₘₐₓ is acquired. In step 2, information (rⱼ, θⱼ, ψⱼ) of the neighbor aircraft is sorted in preferential ascending order of θⱼ, as viewed from the directionality. Step 3 is executed then. In step 3, there is checked the zone, namely repulsion zone, parallel-orientation zone or approach zone, in which each aircraft is located, in the order as sorted in step 2, and the motion direction of each aircraft is determined in accordance with the respective repulsion, parallel-orientation and approach rule. If jₘₐₓ is greater than N_{b,max}, the process ends when j equals N_{b,max}. If jₘₐₓ is smaller than N_{b,max}, the process ends when j equals jₘₐₓ. As a result, a number N_{b,max} of aircraft are selected on the basis of a preferential direction when the total number of neighbor aircraft jₘₐₓ is greater than the maximum value N_{b,max}. In step 4, motion direction is integrated for all the aircraft, and the magnitude of the sum vector is calculated. In step 5, the motion direction of the target aircraft is determined and controlled based on the calculated value. Group control is realized by repeating this process in the time axis for all the target aircraft.

Fields of application of the present invention include the following.

1) Use in Aircraft-Assisted Disaster Prevention Systems, Meteorological Measurement Systems and Reconnaissance Systems

Ongoing research is focusing on the use of unmanned aircraft in, for instance, aerial information gathering in disaster areas, long-term meteorological observation and the like. In these fields, group control of unmanned flying objects allows data to be gathered simultaneously over a wide area. Moreover, the damage caused by crashes is very slight when using small flying objects, and hence the latter can be used over cities. Meanwhile, America is using unmanned aircraft for reconnaissance missions in combat areas. Group control can also be used for this purpose, by employing small flying objects that are easy to transport thanks to their light weight, and which do not require large airfields.

2) Use in Extreme Exploration Such As Space and Deep-Sea Exploration

One of the characteristics of group control, namely redundancy, allows the functionality of remaining aircraft to be preserved even if a small number of aircraft should malfunction. This feature can be used advantageously in extreme exploration, for instance space and deep-sea exploration, to prevent observational failures due to equipment malfunction.

3) Use in Automobile Collision Prevention Systems

Group control algorithms for preventing collisions between automobiles can be used in environments where numerous automobiles move in dense concentrations, for instance in urban roads, highways and the like.

4) Use in Systems for Estimating the Motion of Pedestrian Groups

The movement of pedestrians in urban areas is a combination of following pedestrians ahead, adopting the motion direction of neighbor pedestrians, and modifying one's heading to avoid collisions. This is very similar to the group control algorithm of the present invention. Group control simulation can thus be used as a disaster-prevention tool for predicting the movement of pedestrian groups when a disaster hits, for instance an earthquake or a fire.

5) Use in Structure Design Systems that Account for Human Movement

The movement of people in building structures where large numbers of people congregate, such as railway stations and department stores, can be made smoother by predicting the movement of people inside such structures using group control simulation at the design stage. Group control simulation can be used as a system for helping design the layout of, for instance, pillars, walls and stairs that are suitable for emergency exits during disasters.

What is claimed is:

1. A method for three-dimensional group control of moving objects, the method comprising: setting, around individual moving objects, an interaction zone formed in a spherical or ellipsoidal three-layer structure of, sequentially from outside to inside thereof, an approach zone, a parallel-orientation zone and a repulsion zone; and employing, as an algorithm, a behavior model which comprises an approach rule, a parallel-orientation rule and a repulsion rule depending on the zone at which a neighbor moving object is present.

2. The method for three-dimensional group control of moving objects according to claim 1, wherein the approach rule yields a direction towards a neighbor moving object, the parallel-orientation rule yields a motion direction identical to that of the neighbor moving object, and the repulsion rule yields a direction along a vector c1 or c2 which forms the smallest angle with a motion vector b of an object aircraft. The vectors c1 and c2 lie within a plane defined by the motion vector b and a position vector a of a neighbor individual, such that c1 and c2 have the same origin as a and are perpendicular to a.

3. The method for three-dimensional group control of moving objects according to claim 1, wherein a turning flight around a fixed point is realized by employing an interaction directionality rule whereby an aircraft close to a specific direction is preferentially selected from among neighbor aircraft present in the interaction zone, and by tilting said specific direction towards the center of turning.

4. The method for three-dimensional group control of moving objects according to claim 2, wherein the turning flight around a fixed point is realized by employing an interaction directionality rule whereby an aircraft close to a specific direction is preferentially selected from among neighbor aircraft present in the interaction zone, and by tilting said specific direction towards the center of turning.

5. The method for three-dimensional group control of moving objects according to claim 3, wherein a turning radius is modified by changing an angle of the specific direction.

6. The method for three-dimensional group control of moving objects according to claim 4, wherein the turning radius is modified by changing the angle of the specific direction.

7. The method for three-dimensional group control of moving objects according to claim 1, wherein path control of a whole group of a plurality of aircraft is realized by controlling the motion direction of one or more aircraft among the plurality of aircraft that make up the group, and by causing the remaining aircraft to follow the one or more aircraft through interaction therewith.

8. The method for three-dimensional group control of moving objects according to claim 2, wherein path control of a whole group of a plurality of aircraft is realized by controlling the motion direction of one or more aircraft among the plurality of aircraft that make up the group, and by causing the remaining aircraft to follow the one or more aircraft through interaction therewith.

9. The method for three-dimensional group control of moving objects according to claim 1, utilizing a correlation that arises between a shape of the interaction zone around an aircraft and a shape of the whole group, the shape of the interaction zone being manipulated to control thereby the shape of the whole group to have a desired shape.

10. The method for three-dimensional group control of moving objects according to claim 2, utilizing a correlation that arises between a shape of the interaction zone around an aircraft and a shape of the whole group, the shape of the interaction zone being manipulated to control thereby the shape of the whole group to have a desired shape.
